(19) United States
(12) Patent Application Publication
(10) Pub. No.: US 2014/0372502 A1
(43) Pub. Date: Dec. 18, 2014

(54) COMMUNICATION DEVICE SEARCHING METHOD, COMMUNICATION DEVICE, AND AD HOC NETWORK SYSTEM

(71) Applicant: FUJITSU LIMITED, Kawasaki-shi (JP)

(72) Inventors: Takahiro SHIRAKAWA, Yokohama (JP); Hiroaki TAMAI, Kawasaki (JP); Satoshi IKEDA, Tokyo (JP); Hiroaki KAWASUMI, Tokyo (JP); Mitsuaki YASUOKA, Tokyo (JP); Masahiro MACHIDA, Tokyo (JP); Satoshi KUROSAWA, Tokyo (JP); Shigemasa MATSUBARA, Tokyo (JP); Yoshihiko SHIROKURA, Tokyo (JP)

(73) Assignee: FUJITSU LIMITED, Kawasaki-shi (JP)

(21) Appl. No.: 14/474,678

(22) Filed: Sep. 2, 2014

Related U.S. Application Data
(63) Continuation of application No. PCT/JP2013/055746, filed on Mar. 1, 2013.

(30) Foreign Application Priority Data
Mar. 2, 2012 (JP) 2012-047357

(51) Int. Cl. H04L 29/08

(52) U.S. Cl. CPC H04L 67/10
USPC 709/201

(57) ABSTRACT

A mobile terminal being a searching source that searches for a communication device transmits a searching request addressed to a communication device being a searching destination using a plurality of channels without waiting for a reply to the searching request. A communication device adjacent to the mobile terminal being the searching source, upon receiving a reply to the searching request transmitted by the transmitting from the searching destination, holds the received reply. The mobile terminal being the searching source transmits an inquiry to the adjacent communication device using a plurality of channels about whether a reply to the transmitted searching request has been received from the searching destination. With this configuration, in an ad hoc network with a reactive scheme, the time taken for searching related to a partner device can be shortened.

### CROSS-REFERENCE TO RELATED APPLICATION(S)

This application is a continuation of International Application No. PCT/JP2013/055746, filed on Mar. 1, 2013 which claims the benefit of priority of the prior Japanese Patent Application No. 2012-047357, filed on Mar. 2, 2012, the entire contents of which are incorporated herein by reference.

### FIELD

The embodiment discussed herein is related to a communication device searching method and other related aspects.

### BACKGROUND

In recent years, ad hoc networks have been used in which one or more radio communication devices are relayed from a radio communication device being a transmission source to a radio communication device being a destination and multi-hop communication is used to transmit information. In such an ad hoc network, communication can be performed using a plurality of logical communication channels with the frequencies changed. However, only one channel can be used for communication at one time. More specifically, each of the radio communication devices performs communication using one channel among a plurality of channels.

When a radio communication device as described above performs communication with a partner device by which the channel used for communication is unknown among a plurality of channels, the channel used by the partner device needs to be identified.

In a proactive scheme, which is one of the routing protocols, the routes of all devices in a network are established in advance in each radio communication device. With this scheme, a radio communication device being a transmission source transmits an inquiry to an adjacent device using each channel about whether the partner device uses the channel, whereby the time taken to search the channel used by the partner device is shortened.

In contrast, in a reactive scheme, which is one of the routing protocols, the routes of devices in a network are not established in advance in each radio communication device. With this scheme, a radio communication device being a transmission source attempts to transmit a route request (RREQ) to a communicating partner device using each channel when performing communication. The radio communication device being a transmission source thus determines presence or absence of a reply to identify a channel used by the partner device.

Related-art examples are described in Japanese Laid-open Patent Publication No. 2008-66861.

However, an ad hoc network with a conventional reactive scheme, in which communication can be performed using a plurality of channels, has a problem in that the process of searching related to a partner device takes a long time.

A conventional reactive scheme will now be described with reference to FIG. 13. FIG. 13 is a diagram illustrating a conventional reactive scheme. As illustrated in FIG. 13, a radio communication device being a transmission source (transmission source node) attempts to transmit a route request (RREQ) to a target node sequentially using each channel (CH). In this process, the transmission source node attempts to transmit an RREQ to a target node (node Z, for example) using CH₂. The transmission source node then waits for a reply, and confirms that no reply is received before moving to the next channel. Subsequently, the transmission source node attempts to transmit an RREQ to the target node using CH₂. The transmission source node then waits for a reply, and confirms that no reply is received before moving to the next channel. The transmission source node repeats transmitting an RREQ and confirming presence or absence of a reply using each channel. The transmission source node then receives a reply (RREP: Route Reply) from the node Z to identify the channel CH_{N} is used by the target node. As described above, the transmission source node waits for a determination of presence or absence of a reply to a route request sequentially using each channel, and the process of searching related to a target node thus takes a long time.

Described further with reference to FIG. 14 will be the problem that the process of searching related to a partner device takes a long time. FIG. 14 is a diagram illustrating the problem that the process of searching related to a partner device takes a long time. As illustrated in FIG. 14, the X coordinate represents a time and the Y coordinate represents a channel. The transmission source node transmits an RREQ using CH₁ and waits for a reply. As no reply is received using CH₁, the transmission source node then transmits an RREQ using CH₂ and waits for a reply. As no reply is received using CH₂ again, the transmission source node sequentially changes channels and transmits an RREQ using the changed channels and waits for a reply. The transmission source node then receives a reply when transmitting an RREQ using CH_{N}. More specifically, the transmission source node succeeds in searching related to a partner device being a target node using CH_{N}. As described above, the transmission source node waits for replies for the N number of channels, and the process of searching related to a partner device thus takes a long time.

Furthermore, as illustrated in FIGS. 13 and 14, a successful searching result is not always obtained with respect to a target node. For example, if the number of multi-hops is limited or the location of the transmission source node has a communication limit, a successful searching result is not always obtained with respect to a target node even if the transmission source node waits for the replies for the number of the channels. In an ad hoc network with a reactive scheme, in which communication can be performed using a plurality of channels, it is thus desired that a searching result with respect to a target node be obtained quickly.

### SUMMARY

According to an aspect of an embodiment, a communication device searching method searches for a communication device constituting an ad hoc network communicable using a plurality of channels. The method includes, by a first communication device corresponding to a searching source that searches for a communication device, transmitting a searching request addressed to a third communication device corresponding to a searching destination using a plurality of channels without waiting for a reply to the searching request. The method includes, by a second communication device corresponding to a communication device adjacent to the first communication device, upon receiving a reply to the searching request transmitted at the transmitting the searching request from the third communication device, holding the received reply. The method includes, by the first communication device, transmitting an inquiry to the second communication device using a plurality of channels about whether a reply to the searching request transmitted at the transmitting the searching request has been received from the third communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of an ad hoc network system according to an embodiment;

FIG. 2 is a diagram illustrating an example format of a route request packet;

FIG. 3 is a diagram illustrating an example format of a reply packet;

FIG. 4 is a flowchart illustrating the procedure of processing performed by a transmission source node according to the embodiment;

FIG. 5 is a flowchart illustrating the procedure of processing performed by a relay node according to the embodiment;

FIG. 6 is a flowchart illustrating the procedure of processing performed by a destination node according to the embodiment;

FIG. 7 is a diagram illustrating a specific example of an ad hoc network according to the embodiment;

FIG. 8 is a diagram illustrating a data flow of a route request according to the embodiment;

FIG. 9 is a diagram illustrating a data flow of a reply inquiry according to the embodiment;

FIG. 10 is a diagram (1) illustrating a relation between a time and a channel for communication device searching processing according to the embodiment;

FIG. 11 is a diagram (2) illustrating a relation between a time and a channel for communication device searching processing according to the embodiment;

FIG. 12 is a diagram illustrating a computer executing a communication device searching program;

FIG. 13 is a diagram explaining a conventional reactive scheme; and

FIG. 14 is a diagram explaining the problem that the process of searching related to a partner device takes a long time.

### DESCRIPTION OF EMBODIMENT

Preferred embodiments of the present invention will be explained with reference to accompanying drawings. It is noted that the embodiment describes a case where a portable mobile terminal searches for a communication device in an ad hoc network with a reactive scheme, in which communication can be performed using a plurality of channels, but the embodiment is not intended to limit the present invention.

Configuration of an Ad Hoc Network System According to an Embodiment

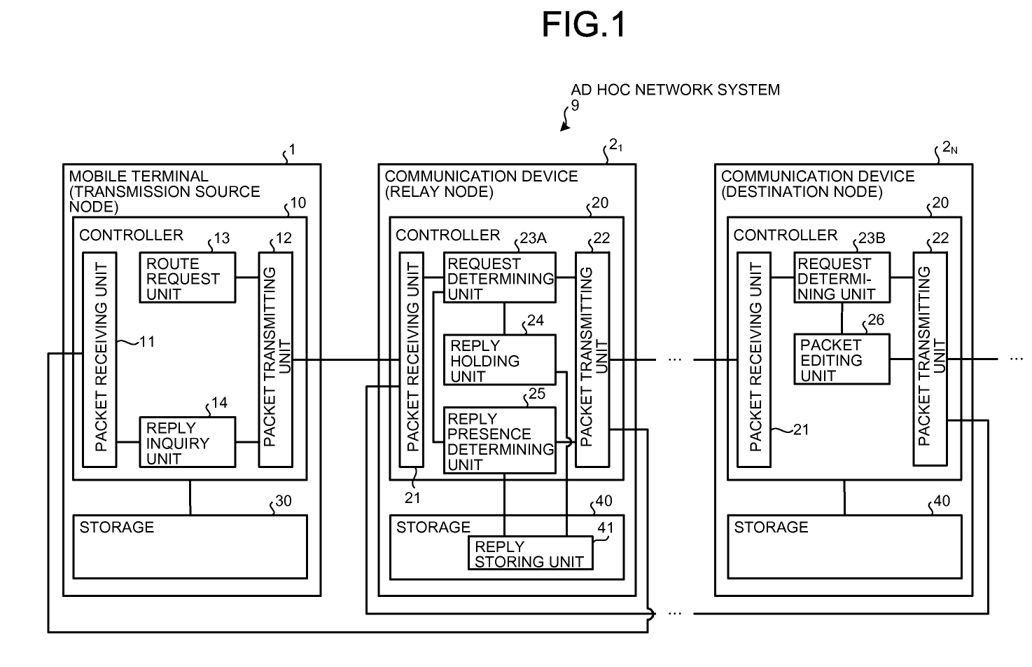

Described will be an example of a configuration of an ad hoc network system 9 according to an embodiment. FIG. 1 is a functional block diagram illustrating the configuration of the ad hoc network system according to the embodiment. As illustrated in FIG. 1, the ad hoc network system 9 includes a mobile terminal 1 and a plurality of communication devices 2 configured to communicate with each other using a same channel. It is noted that a plurality of channels are present, each of which corresponds to a different frequency band. For ease of explanation, with regard to the communication device 2, a relay node is referred to as a communication device 2₁ and a destination node is referred to as a communication device 2_{N}.

When the ad hoc network system 9 transmits data from the mobile terminal 1 (transmission source node) to the communication device 2_{N} (destination node), the ad hoc network system 9 transmits the data from the mobile terminal 1 to the destination communication device 2_{N} by multi-hop communication. More specifically, the mobile terminal 1 transmits the data to the destination communication device 2_{N} via the communication device 2₁ adjacent thereto.

Configuration of Mobile Terminal 1

The mobile terminal 1 transmits a searching request addressed to a destination communication device using a plurality of channels without waiting a reply to the searching request. Furthermore, after transmitting the searching request, the mobile terminal 1 transmits an inquiry to an adjacent device using a plurality of channels about whether a reply has been received from the destination communication device. It is noted that the mobile terminal 1 corresponds to a handy terminal, for example. However the mobile terminal 1 is not limited thereto, but may be a mobile phone, a personal digital assistant (PDA), or a portable personal computer.

The mobile terminal 1 includes a controller 10 and a storage 30. The controller 10 is an integrated circuit such as an application specific integrated circuit (ASIC) and a field programmable gate array (FPGA) or an electronic circuit such as a central processing unit (CPU) and a micro processing unit (MPU). The controller 10 further includes a packet receiving unit 11, a packet transmitting unit 12, a route request unit 13, and a reply inquiry unit 14.

The storage 30 is a semiconductor memory element such as a random access memory (RAM) and a flash memory or a storing device such as a hard disc and an optical disc.

The route request unit 13 changes channels and controls the packet transmitting unit 12 to transmit a route request addressed to the communication device 2_{N} being the searching destination using each of the changed channels. The route request is transmitted using a route request packet described later. It is noted that the route request unit 13 only performs transmission using each channel and does not wait for a reply to the transmission.

The reply inquiry unit 14 changes channels and controls the packet transmitting unit 12 to transmit an inquiry request about whether a reply has been received from the searching destination to an adjacent communication device 2₁ using each of the changed channels. For example, after the route request unit 13 transmits a route request using each channel, the reply inquiry unit 14 performs polling to inquire about a reply using each channel.

The packet receiving unit 11 receives a reply to the inquiry request from the adjacent communication device 2₁. The response is received using a reply packet, which will be described later. The packet transmitting unit 12 transmits various packets to the channels.

Configuration of Communication Device 2

The communication device 2 corresponds to an information processing device such as a personal computer and a workstation, for example, but may be any device that can communicate with the mobile terminal 1.

The communication device 2₁ as a relay node includes a controller 20 and a storage 40. The controller 20 is an integrated circuit such as an ASIC and an FPGA or an electronic circuit such as a CPU and an MPU. The controller 20 further includes a packet receiving unit 21, a packet transmitting unit 22, a request determining unit 23A, a reply holding unit 24, and a reply presence determining unit 25.

The storage 40 is a semiconductor memory element such as a random access memory (RAM) and a flash memory or a storing device such as a hard disc and an optical disc. The storage 40 includes a reply storing unit 41. The reply storing unit 41 stores therein the reply packet.

The packet receiving unit 21 receives various packets using a channel used by the host communication device. The packet transmitting unit 22 transmits various packets using a channel used by the host communication device.

The request determining unit 23A makes a determination on various requests and allocates the processing. For example, in the case of a searching request from the mobile terminal 1, the request determining unit 23A determines whether the host communication device is a destination included in the searching request. If the request determining unit 23A determines that the host communication device is not a destination included in the searching request, the request determining unit 23A relays the searching request using a channel used by the host communication device. In this case, the request determining unit 23A relays the searching request because the host communication device is a relay node, not a destination node. Furthermore, in the case of a reply to a searching request, the request determining unit 23A allocates the processing to the reply holding unit 24. In the case of an inquiry request from the mobile terminal 1, the request determining unit 23A allocates the processing to the reply presence determining unit 25.

When the reply includes an instruction that the reply is held one hop before the transmission source and the host communication device is one hop before the transmission source, the reply holding unit 24 controls the reply storing unit 41 to store therein the reply so that the reply is held. It is noted that the determination of being one hop before is made in a manner that when an RREQ is received, it is recorded whether the RREQ is received directly from the node being the transmission source without using a relay node, for example.

The reply presence determining unit 25 determines whether the reply is held based on the reply storing unit 41. If the reply presence determining unit 25 determines that the reply is held in the reply storing unit 41, the reply presence determining unit 25 controls the packet transmitting unit 22 to transmit the held reply to the mobile terminal 1 being the transmission source. With this configuration, the mobile terminal 1 being the transmission source receives the reply from the communication device in which the reply was held, and thus identifies the channel used for the receiving as the channel of the communication device 2_{N} being the searching destination.

In the communication device 2_{N} as the destination node, the same units as those in the communication device 2₁ are denoted by the same reference signs and the descriptions thereof are omitted. The differences between the communication device 2_{N} and the communication device 2₁ is that a request determining unit 23B is provided instead of the request determining unit 23A and a packet editing unit 26 is added in the communication device 2_{N}. It is noted that the communication device 2_{N} and the communication device 2₁ actually are communication devices including the same configuration, in which the configurations of the devices are merged.

The request determining unit 23B makes a determination on various requests and allocates the processing. For example, in the case of a searching request from the mobile terminal 1, the request determining unit 23B determines whether the host communication device is a destination included in the searching request. If the request determining unit 23B determines that the host communication device is the destination included in the searching request, the request determining unit 23B allocates the processing to the packet editing unit 26.

The packet editing unit 26 creates a reply packet including an instruction that the reply is held one hop before the transmission source, as the reply to the searching request. The packet editing unit 26 then controls to transmit the created reply packet, addressed to the mobile terminal 1 being the transmission source. With this configuration, the communication device 2₁, which is one hop before the mobile terminal 1, being the transmission source can receive the reply packet and hold the received reply packet if the communication device 2₁ uses the same channel as that used by the communication device 2_{N} being the destination.

Example of Packet Format

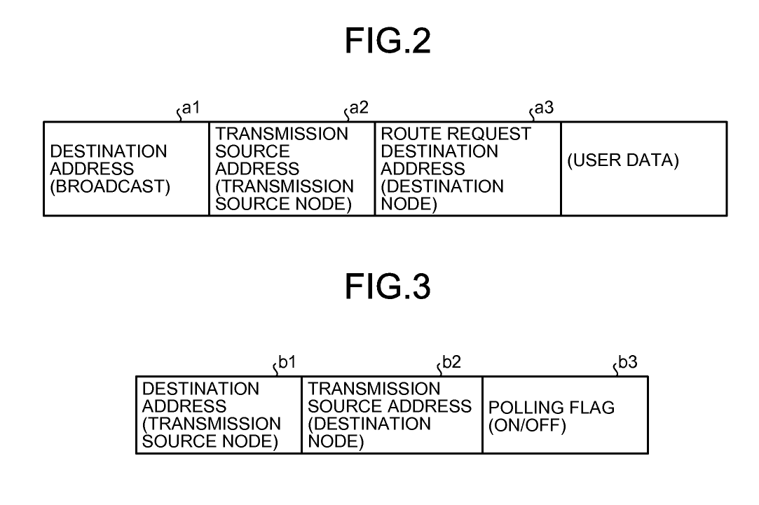

Next, described with reference to FIGS. 2 and 3 will be packet formats of the route request packet and the reply packet. FIG. 2 is a diagram illustrating an example format of the route request packet. FIG. 3 is a diagram illustrating an example format of the reply packet. It is noted that the route request packet is referred to as an RREQ and the reply packet is referred to as an RREP.

As illustrated in FIG. 2, the route request packet includes a destination address a1, a transmission source address a2, and a route request destination address a3. To the destination address a1, a unicast address specifying the destination address of the adjacent communication device 2₁ is set for broadcast as an example. As another example, a multicast address that can be received only by the adjacent communication device 2₁ is set. As an example of the multicast address that can be received only by the adjacent communication device 2₁, an address used in a bridge protocol data unit (BPDU), which is used in a spanning tree protocol (STP).

To the transmission source address a2, the address of the transmission source node is set. More specifically, to the transmission source address a2, the address of the mobile terminal 1 is set.

To the route request destination address a3, the address of the destination node is set. More specifically, to the route request destination address a3, the address of the communication device 2_{N} is set.

As illustrated in FIG. 3, the reply packet includes a destination address b1, a transmission source address b2, and a polling flag b3. To the destination address b1, the address of the transmission source node being the destination of the reply. More specifically, to the destination address b1, the address of the mobile terminal 1 is set.

To the transmission source address b2, the address of the destination node being the transmission source of the reply is set. More specifically, to the transmission source address b2, the address of the communication device 2_{N} is set.

The polling flag b3 is a flag indicating whether the transmission source node acquires the reply by polling. More specifically, the polling flag b3 is a flag indicating an instruction that the reply is held by a node one hop before the transmission source node. In the case of the instruction that the reply is held by a node one hop before the transmission source node, ON is set, for example. If not the case of the instruction that the reply is held by a node one hop before the transmission source node, OFF is set, for example. More specifically, the packet editing unit 26 sets the address of the mobile terminal 1 to the destination address b1, sets the address of the host communication device to the transmission source address b2, and creates a reply packet so as to set ON to the polling flag b3, as the reply to the searching request.

Procedure of Processing Performed by Transmission Source Node

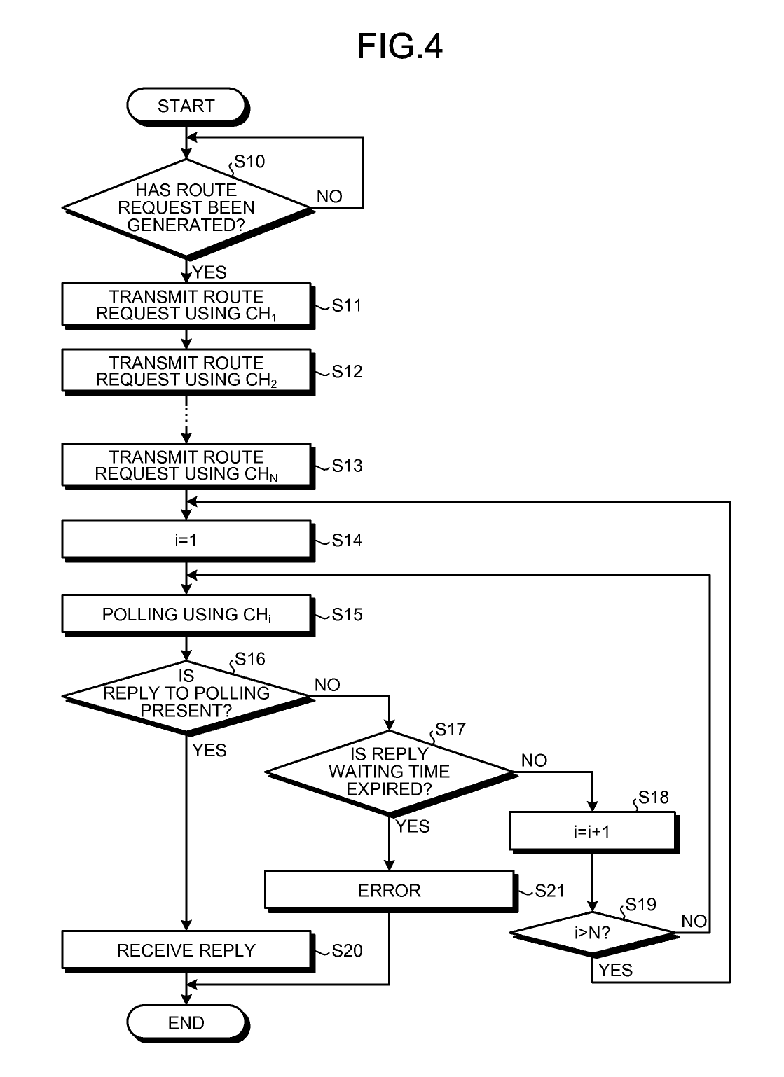

Next, described with reference to FIG. 4 will be the procedure of processing performed by the transmission source node. FIG. 4 is a flowchart illustrating the procedure of processing performed by the transmission source node according to the embodiment. It is noted that in the flow chart described below, a channel is abbreviated as CH. Furthermore, the maximum number of the communicable channels shall be N (N is an integer larger than 1).

Firstly, the route request unit 13 determines whether any route request has been generated (Step S10). If the route request unit 13 determines that no route request has been generated (No at S10), the route request unit 13 repeats the determination processing. In contrast, if the route request unit 13 determines that a route request has been generated (Yes at S10), the route request unit 13 controls to transmit the route request, that is, a route request packet using CH₂ (Step S11). Subsequently, the route request unit 13 controls to transmit the route request using CH₂ (Step S12). The route request unit 13 further controls to transmit the route request using CH_{N} (Step S13).

Thereafter, the reply inquiry unit 14 sets 1 to an index i (Step S14). The reply inquiry unit 14 then performs polling, that is, transmits an inquiry request using CH₂ (Step S15). The reply inquiry unit 14 then determines whether any reply to the polling is present (Step S16).

If the reply inquiry unit 14 determines that no reply to the polling is present (No at S16), the reply inquiry unit 14 determines whether a reply waiting time is expired (Step S17). If the reply inquiry unit 14 determines that the reply waiting time is not expired (No at S17), the reply inquiry unit 14 adds 1 to the value of the index i (Step S18). Thereafter, the reply inquiry unit 14 determines whether the value of the index i is larger than N (Step S19).

If the reply inquiry unit 14 determines that the value of the index i is larger than N (Yes at S19), the reply inquiry unit 14 moves to Step S14 to perform polling again sequentially from CH'. In contrast, if the reply inquiry unit 14 determines that the value of the index i is not larger than N (No at S19), the reply inquiry unit 14 moves to Step S15 to perform polling using CHᵢ.

At Step S16, if the reply inquiry unit 14 determines that a reply to the polling is present (Yes at S16), the reply inquiry unit 14 controls to receive a reply packet to the polling (Step S20). The processing at the transmission source node is then terminated.

At Step S17, if the reply inquiry unit 14 determines that the reply waiting time is expired (Yes at S17), the reply inquiry unit 14 determines that an error has occurred (Step S21). For example, the reply inquiry unit 14 outputs the result that no reply to the route request was present on the display of the host mobile terminal 1. The processing at the transmission source node is then terminated.

Procedure of Processing Performed by Relay Node

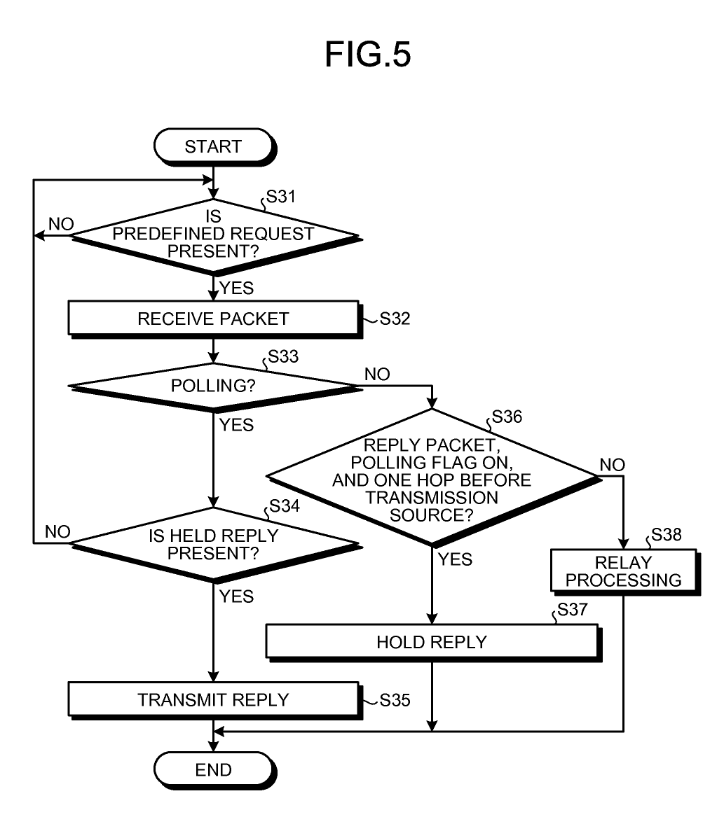

Next, described with reference to FIG. 5 will be the procedure of processing performed by the relay node. FIG. 5 is a flowchart illustrating the procedure of processing performed by the relay node according to the embodiment.

Firstly, the request determining unit 23A determines whether any predefined request is present (Step S31). If the request determining unit 23A determines that no predefined request is present (No at S31), the request determining unit 23A repeats the determination processing. In contrast, if the request determining unit 23A determines that a predefined request is present (Yes at S31), the request determining unit 23A controls to receive a packet related to the request (Step S32).

The request determining unit 23A then determines whether the received packet was sent by polling (Step S33). If the request determining unit 23A determines that the received packet was sent by polling (Yes at S33), the reply presence determining unit 25 determines whether any reply packet is held in the reply storing unit 41 (Step S34).

If the reply presence determining unit 25 determines that a reply packet is held in the reply storing unit 41 (Yes at S34), the reply presence determining unit 25 controls to transmit the held reply packet to the transmission source node (Step S35). The processing at the relay node is then terminated. In contrast, the reply presence determining unit 25 determines that no reply packet is held in the reply storing unit 41 (No at S34), the reply presence determining unit 25 moves to Step S31 to wait for the next request.

At Step S33, if the request determining unit 23A determines that the received packet was not sent by polling (No at S33), the request determining unit 23A determines whether the received packet is a packet to be held (Step S36). If the request determining unit 23A determines that the received packet is a reply packet, the polling flag is ON, and the host communication device is one hop before the transmission source node (Yes at S36), the reply holding unit 24 determines that the packet is a packet to be held and controls the reply storing unit 41 to hold therein the reply packet (Step S37). The processing at the relay node is then terminated.

In contrast, if the request determining unit 23A determines that the received packet is not a packet to be held (No at S36), the request determining unit 23A controls to relay the received packet (Step S38). The request determining unit 23A determined that the received packet was a route request packet. The processing at the relay node is then terminated.

Procedure of Processing Performed by Destination Node

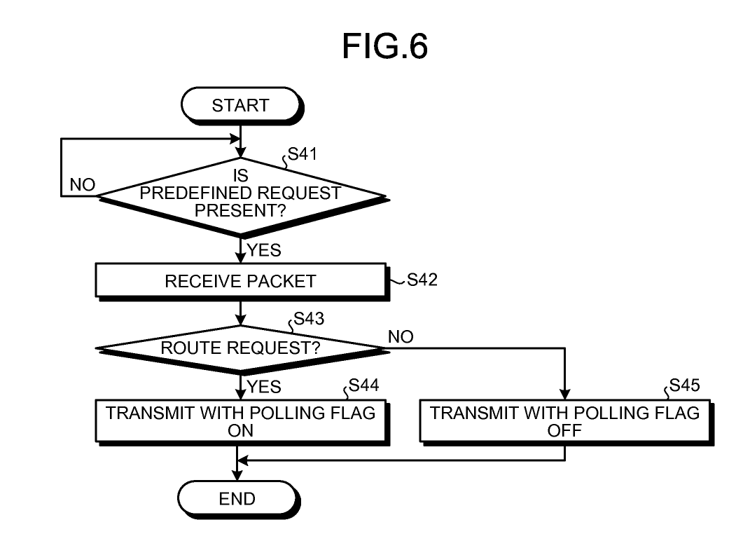

Next, described with reference to FIG. 6 will be the procedure of processing performed by the destination node. FIG. 6 is a flowchart illustrating the procedure of processing performed by the destination node according to the embodiment.

Firstly, the request determining unit 23B determines whether any predefined request is present (Step S41). If the request determining unit 23B determines that no predefined request is present (No at S41), the request determining unit 23B repeats the determination processing. In contrast, if the request determining unit 23B determines that a predefined request is present (Yes at S41), the request determining unit 23B controls to receive a packet related to the request (Step S42).

The request determining unit 23B then determines whether the received packet is a route request packet (Step S43). If the request determining unit 23B determines that the received packet is a route request packet (Yes at S43), the packet editing unit 26 sets the polling flag b3 to ON and controls to transmit a response packet (Step S44). More specifically, the packet editing unit 26 creates a reply packet including an instruction that the reply is held one hop before the transmission source, as the reply to the searching request packet. The packet editing unit 26 then controls to transmit the created reply packet. The processing at the destination node is then terminated.

In contrast, if the request determining unit 23B determines that the received packet is not a route request (No at S43), the request determining unit 23B controls to transmit a response packet with the polling flag b3 still set to OFF (Step S45). The processing at the destination node is then terminated.

Specific Example of Ad Hoc Network

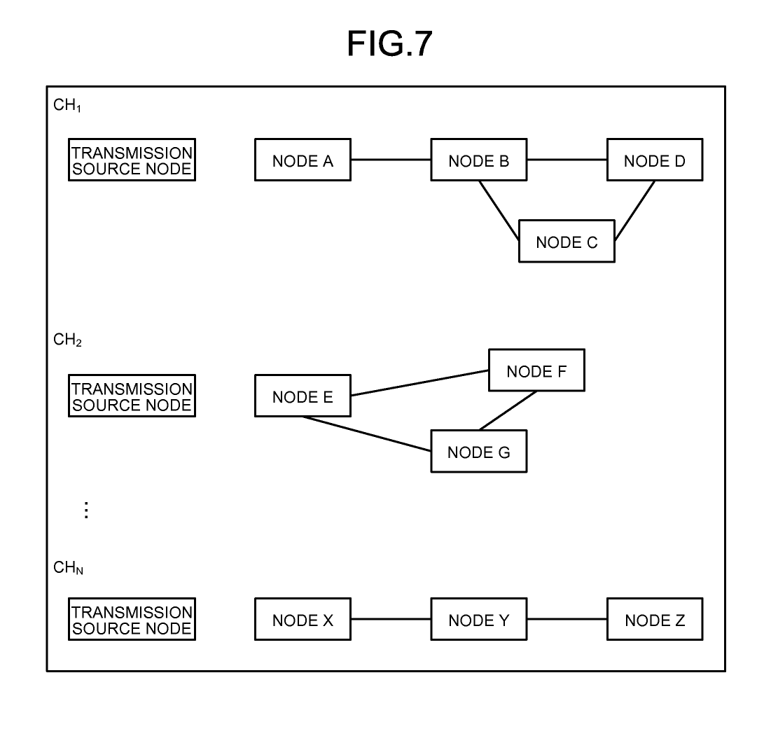

Next, described with reference to FIG. 7 will be a specific example of an ad hoc network according to the present embodiment. FIG. 7 is a diagram illustrating the specific example of the ad hoc network according to the embodiment. It is noted that in FIG. 7, a channel is abbreviated as CH. Furthermore, the maximum number of the communicable channels shall be N (N is an integer larger than 1).

As illustrated in FIG. 7, using CH₁, a node A, a node B, a node C, and a node D can be communicated by multi-hop communication. If the transmission source node uses CH₁, multi-hop communication can be started from the adjacent node A.

using CH₂, a node E, a node F, and a node G can be communicated by multi-hop communication. If the transmission source node uses CH₂, multi-hop communication can be started from the adjacent node E.

Using CH_{N}, a node X, a node Y, and a node Z can be communicated by multi-hop communication. If the transmission source node uses CH_{N}, multi-hop communication can be started from the adjacent node X.

Data Flows of Route Request and Reply Inquiry

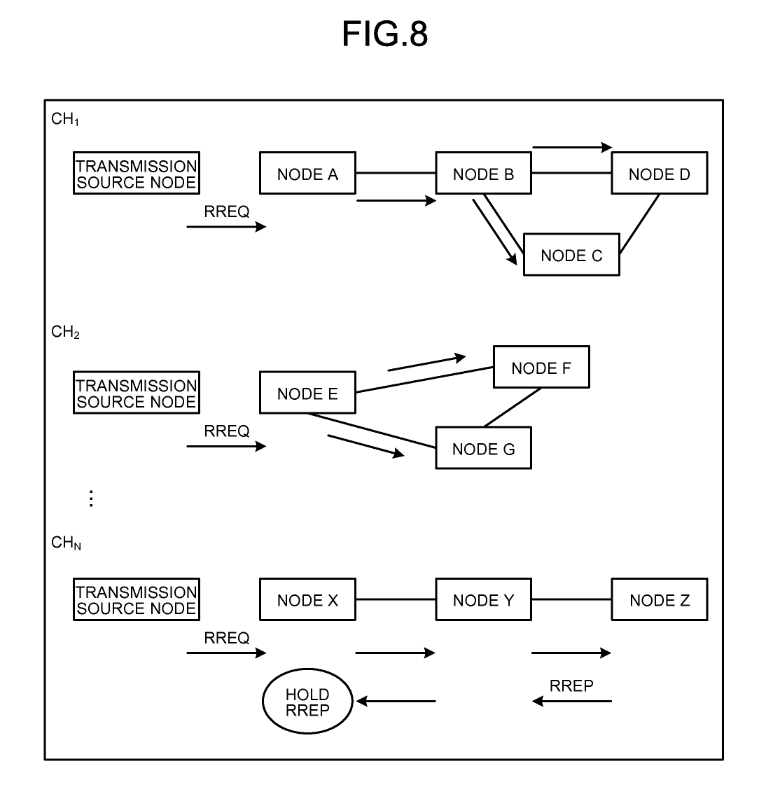

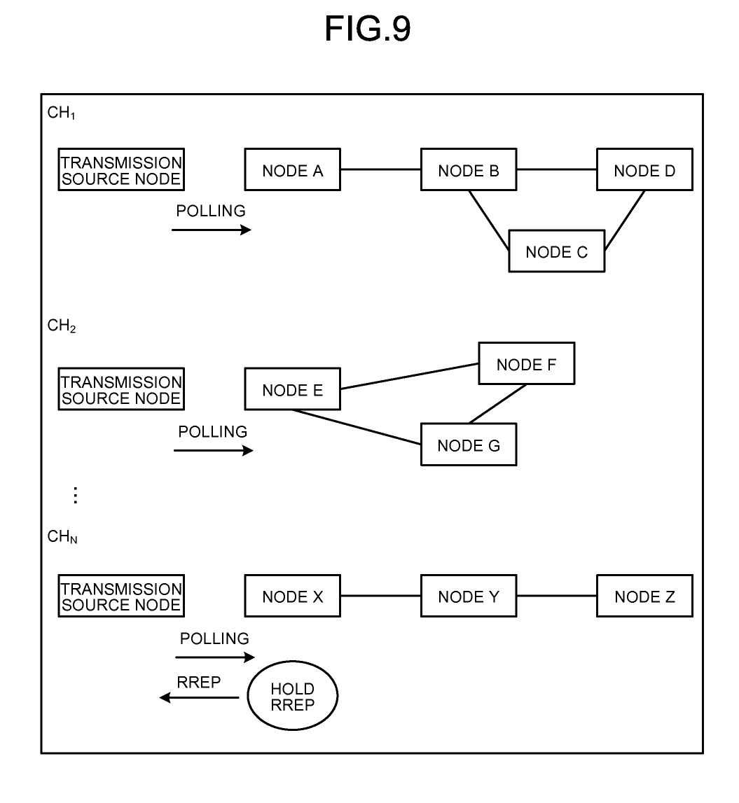

Described below with reference to FIGS. 8 and 9, based on the ad hoc network illustrated in FIG. 7, will be data flows of a route request and a reply inquiry according to the embodiment. FIG. 8 is a diagram illustrating the data flow of a route request according to the embodiment. FIG. 9 is a diagram illustrating the data flow of a reply inquiry according to the embodiment. It is assumed that the node Z is a destination node, and the transmission source node searches for the node Z.

As illustrated in FIG. 8, the transmission source node transmits a route request packet (RREQ) addressed to the node Z using CH₂. The RREQ transmitted from the transmission source node is transmitted from the node A to the node B, from the node B to the node C and the node D. However, no destination node is found because the node Z being the destination is not present in the network where communication can be performed using CH₂.

The transmission source node changes channels to CH₂ without waiting for a reply to the RREQ transmitted using CH₂, and transmits the RREQ addressed to the node Z using CH₂. The RREQ transmitted from the transmission source node is transmitted from the node E to the node F and the node G. However, no destination node is found because the node Z being the destination is not present in the network where communication can be performed using CH₂.

The transmission source node sequentially changes channels without waiting for a reply to the transmitted RREQ, and transmits the RREQ addressed to the node Z using the changed channel. When the transmission source node uses CH_{N} to transmit the same RREQ transmitted using other channels, the RREQ transmitted from the transmission source node is transmitted from the node X to the node Y and from the node Y to the node Z. The node Z being the destination is thus present in the network where communication can be performed using CH_{N}, so that an RREP as a reply packet is transmitted from the node Z. With respect to the RREP, the polling flag b3 is set to ON.

The RREP transmitted from the node Z is transmitted from the node Y to the node X. The node X, which is one hop before the transmission source node, receives the RREP and controls the reply storing unit 41 to store therein the received RREP because the polling flag b3 is set to ON with respect to the received RREP.

Once the transmission source node has transmitted the RREQ addressed to the node Z using CH_{N}, which is the last channel in this case, the transmission source node performs polling sequentially from CH₂. As illustrated in FIG. 9, the transmission source node performs polling using CH₂. More specifically, the polling request corresponds to an inquiry request about whether a reply (RREP) from the node Z being the searching destination has been received. However, the node A does not hold the RREP and thus does not respond to the request.

Subsequently, the transmission source node performs polling using CH₂. However, the node B again does not hold the RREP, and thus does not respond to the request.

The transmission source node sequentially changes channels and performs polling using the changed channel. The transmission source node then performs polling using CH_{N}. The node X holds the RREP and transmits the held RREP to the transmission source node. The transmission source node then receives a reply from the target node, that is, the destination node Z.

As described above, the transmission source node receives the RREP from the node X and thereby identify CH_{N} used in the receiving as the channel used by the destination node Z.

Relation Between Time and Channel for Communication Device Searching Processing

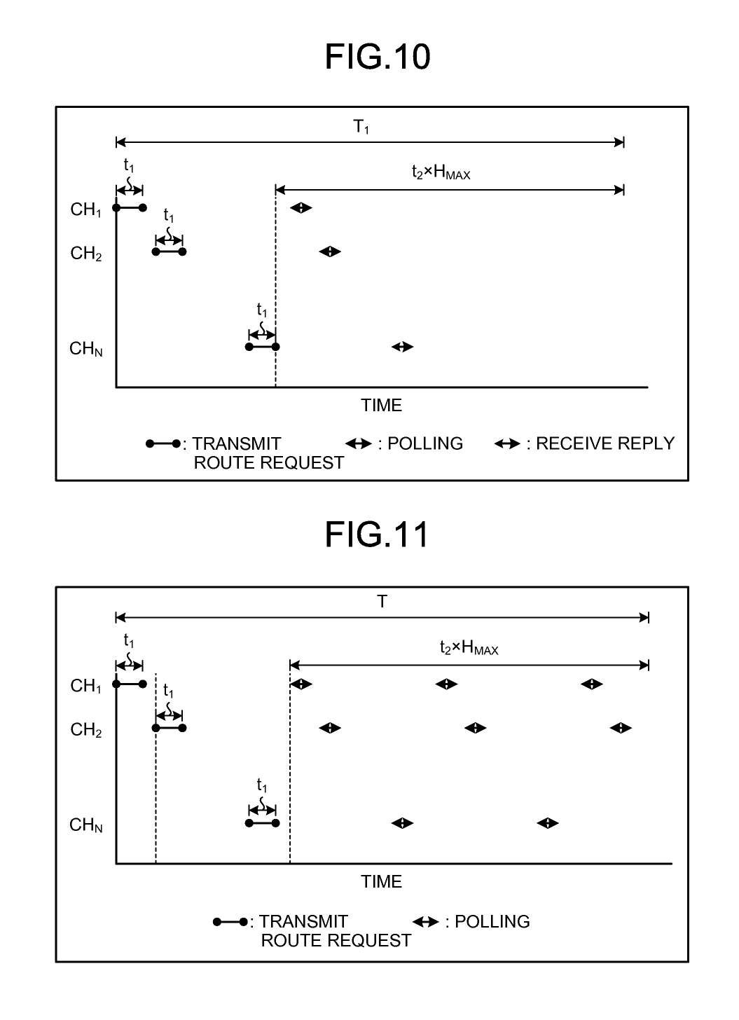

Next, described with reference to FIGS. 10 and 11 will be a relation between a time and a channel for communication device searching processing according to the embodiment. FIGS. 10 and 11 are diagrams each illustrating a relation between a time and a channel for communication device searching processing according to the embodiment. It is noted that in FIGS. 10 and 11, a channel is abbreviated as CH. Furthermore, the maximum number of the communicable channels shall be N (N is an integer larger than 1).

As illustrated in FIG. 10, after transmitting the route request (RREQ) using CH', the transmission source node does not wait for a reply and transmits the RREQ sequentially using CH₂ to CH_{N}. At this point, if the time taken to transmit the route request using one channel is t₁ milliseconds (ms), for example, the total time taken to transmit the route request is t₁×N (ms).

Thereafter, after transmitting the RREQ using all the channels, the transmission source node performs polling using all the channels, sequentially from CH₁. At this point, if the time taken to wait for the route request with respect to one hop is t₂ (ms) and the maximum number of hops is H_{MAX}, the waiting time with respect to the maximum number of hops is t₂×H_{MAX} (ms).

Accordingly, the maximum time taken by the transmission source node to search for the destination node (maximum searching time) T₁ is expressed by the total time taken to transmit the route request added with the reply waiting time with respect to the maximum number of hops, that is, Equation (1).

T₁=t₁×N+t₂×H_{MAX} (ms) (1)

In the example illustrated in FIG. 10, the transmission source node has successfully searched the node Z as the destination node within the range of the maximum searching time T₁ using CH_{N}.

With a conventional reactive scheme, the transmission source node transmits the RREQ using one channel, and after confirming that no reply is received, transmits the RREQ using the next channel to search the destination node. More specifically, the maximum searching time T₂ with the conventional reactive scheme is expressed by Equation (2) described below.

T₂=(t₁+t₂×H_{MAX})×N (ms) (2)

If it is assumed that the destination node of the transmission source node is the node Z, searching can be performed by waiting only for T₂, with the conventional reactive scheme.

To apply specific numbers, it is assumed that the time t₁ taken to transmit the route request using one channel is 10 ms, the time t₂ taken to wait for a reply to the route request with respect to one hop is 100 ms, the maximum number of hops H_{MAX} is 20, and the maximum number of the channels N is 10, for example. According to calculation using these numbers, T₂ is 2,100 ms and T₂ is 20,100 ms. The searching time according to the embodiment thus can be shortened to about one-tenth of that with the conventional reactive scheme.

In contrast, in the example of FIG. 11, a case where the transmission source node has not successfully searched the target node within the range of the maximum searching time T₁. That is the case where the number of multi-hops is limited or the location of the transmission source node has some kind of communication limit. Even in that case, the transmission source node can obtain a searching result of a failure with respect to the target node by waiting only for the maximum searching time T₁. The time taken to obtain a searching result according to the embodiment thus can be shortened to about one-tenth of that with the conventional reactive scheme. With this configuration, the transmission source node can quickly obtain a searching result, so that if the searching result is a failure, the transmission source node can quickly change locations to search, whereby the final searching time can be shortened.

### Effect of the Embodiment

In the embodiment described above, the mobile terminal 1 transmits a searching request addressed to the communication device 2_{N} being the searching destination using a plurality of channels without waiting for a reply to the searching request. If the communication device 2₁ adjacent to the mobile terminal 1 has received a reply to the searching request from the searching destination, the communication device 2₁ holds the received reply. After the mobile terminal 1 transmits the searching request using a plurality of channels, the mobile terminal 1 transmits an inquiry to the communication device 2₁ using a plurality of channels about whether a reply has been received from the searching destination. With this configuration, the time taken by the mobile terminal 1 to search the communication device being the searching destination can be shortened when the channel used by the communication device being the searching destination is unknown.

Furthermore, in the embodiment described above, if the communication device 2_{N} being the searching destination has received the searching request, the communication device 2_{N} transmits a reply to the received searching request in a manner including an instruction that the reply is held one hop before the mobile terminal 1 being the searching source. With this configuration, even while the mobile terminal 1 is performing transmission processing of the searching request, the communication device 2_{N} being the searching destination can control the reply to the searching request to be held one hop before the searching source. As a result, the mobile terminal 1 being the searching source can obtain a reply when transmitting an inquiry using the channel used by the communication device 2₁ holding the reply. The mobile terminal 1 thus can quickly learn the channel used by the communication device 2_{N} being the searching destination, which was unknown.

Computer Program and Other Related Aspects

The embodiment has been described in which the mobile terminal 1 is a transmission source node and the communication device 2 is a relay node and a destination node. However, the mobile terminal 1 may include all the components in the communication device 2. Similarly, the communication device 2 may include all the components in the mobile terminal 1. In this case, in the mobile terminal 1, the request determining unit 23A, the request determining unit 23B, the reply holding unit 24, the reply presence determining unit 25, and the packet editing unit 26 may be added to the controller 10. The mobile terminal 1 may further add the reply storing unit 41 to the storage 30. The communication device 2 may add the route request unit 13 and the reply inquiry unit 14 to the controller 20. Each of the mobile terminal 1 and the communication device 2 thus can be a transmission source node, a relay node, and a destination node, whereby generalization of functions is enabled.

Furthermore, various components in each device illustrated do not necessarily need to be physically structured as illustrated. More specifically, the specific modes of separating or integrating the devices are not limited to those illustrated, and all or part of the devices may be configured in a manner functionally or physically separated or integrated in an optional unit in accordance with the loads, use conditions, and other factors. For example, the route request unit 13 and the reply inquiry unit 14 may be integrated as one unit. On the other hand, the reply presence determining unit 25 may be separated into a determining unit that determines presence or absence of a reply and a holding unit that holds a reply when the reply has been determined to be present. Furthermore, the storages 30 and 40 may be connected via a network to the mobile terminal 1 and the communication device 2 respectively as external devices of the mobile terminal 1 and the communication device 2 respectively.

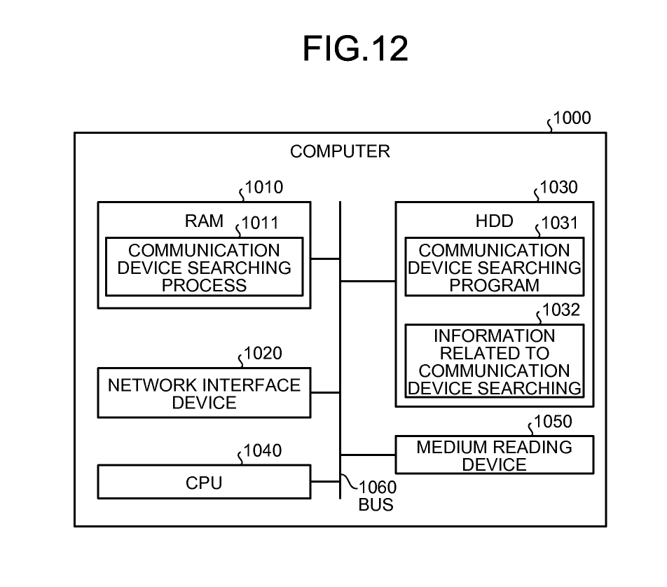

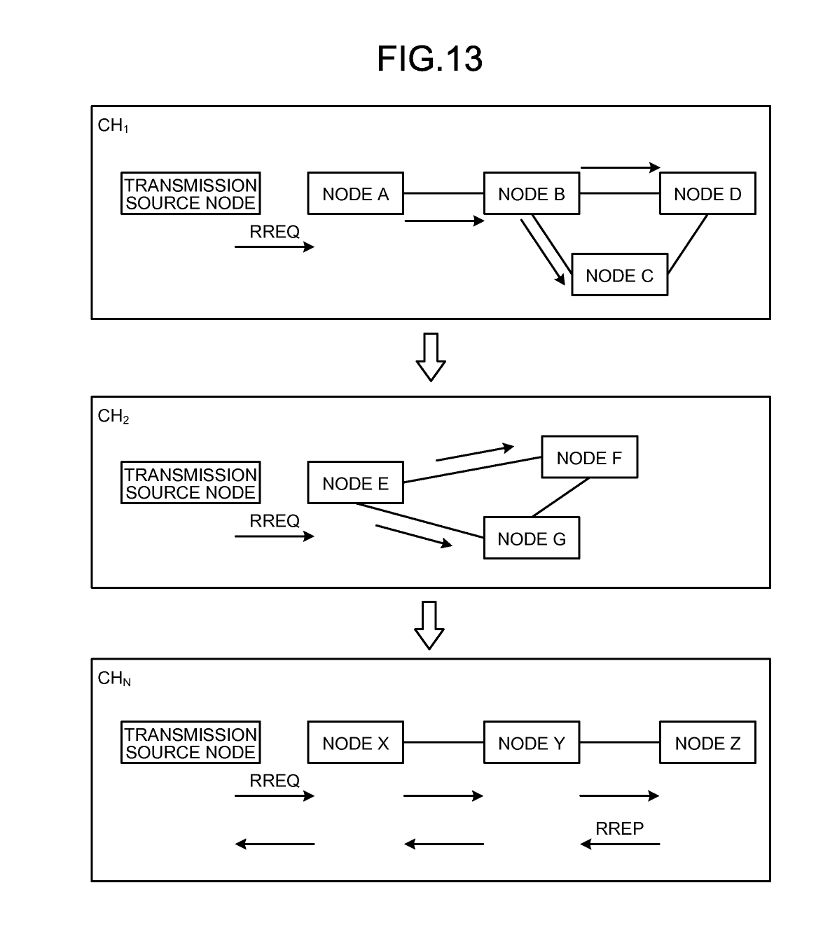

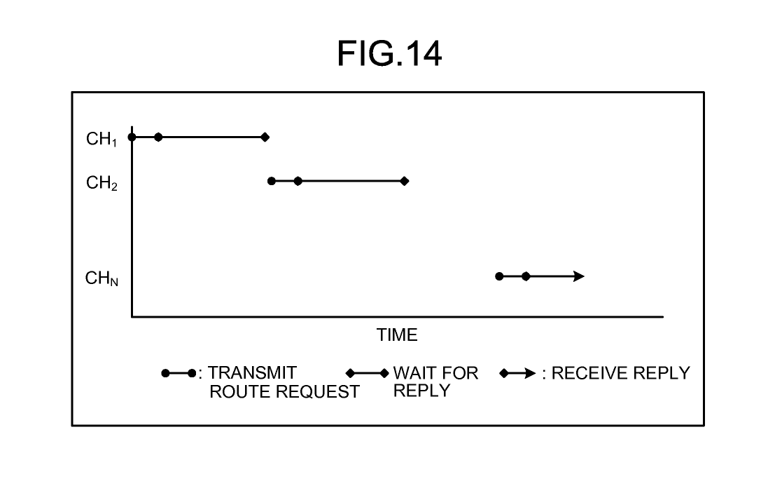

Furthermore, various processing described above in the embodiment may be performed with a prepared program executed by a computer such as a personal computer or a workstation. Described below with reference to FIG. 12 will be an example of a computer executing a communication device searching program having the same function as that of the mobile terminal 1 illustrated in FIG. 1.

FIG. 12 is a diagram illustrating the computer executing the communication device searching program. As illustrated in FIG. 12, a computer 1000 includes a RAM (Random Access Memory) 1010, a network interface device 1020, an HDD (Hard Disk Drive) 1030, a CPU (Central Processing Unit) 1040, a medium reading device 1050, and a bus 1060. The RAM 1010, the network interface device 1020, the HDD 1030, the CPU 1040, and the medium reading device 1050 are connected by a bus 1060.

The HDD 1030 stores therein a communication device searching program 1031 having the same function as that of the controller 10 illustrated in FIG. 1 and information related to communication device searching 1032. The HDD 1030 further corresponds to the storage 30 illustrated in FIG. 1.

The CPU 1040 reads the communication device searching program 1031 from the HDD 1030 and loads the read communication device searching program 1031 on the RAM 1010, whereby the communication device searching program 1031 is caused to function as a communication device searching process 1011. The communication device searching process 1011 then loads information and other data read from the information related to communication device searching 1032 to an area allocated to the communication device searching process 1011 on the RAM 1010 and performs various data processing based on the loaded information and other data.

It is noted that the communication device searching program 1031 described above may not be stored in the HDD 1030 necessarily. This program may be stored in a “portable physical medium” such as a CD-ROM to be read and executed by the computer 1000.

Furthermore, this program may be stored in a different computer (or a server) connected to the computer 1000 via a public network, the Internet, a local area network (LAN), a wide area network (WAN), or the like. In such a case, the computer 1000 reads the program from the computer (or the server) and executes the read program.

According to an aspect of a communication device searching method disclosed herein, in an ad hoc network with a reactive scheme, in which communication can be performed using a plurality of channels, the time taken to perform searching related to a partner device can be shortened.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication device searching method for searching for a communication device constituting an ad hoc network communicable using a plurality of channels, the communication device searching method comprising:
by a first communication device corresponding to a searching source that searches for a communication device, transmitting a searching request addressed to a third communication device corresponding to a searching destination using a plurality of channels without waiting for a reply to the searching request;
by a second communication device corresponding to a communication device adjacent to the first communication device, upon receiving a reply to the searching request transmitted at the transmitting the searching request from the third communication device, holding the received reply; and
by the first communication device, transmitting an inquiry to the second communication device using a plurality of channels about whether a reply to the searching request transmitted at the transmitting the searching request has been received from the third communication device.

2. The communication device searching method according to claim 1, wherein the third communication device, upon receiving the searching request transmitted at the transmitting, transmits a reply to the received searching request in a manner including an instruction that the reply is held in the second communication device.

3. A first communication device constituting an ad hoc network communicable using a plurality of channels, the first communication device comprising:
a searching request unit configured to transmit a searching request addressed to a third communication device corresponding to a searching destination using a plurality of channels without waiting for a reply to the searching request; and
an inquiry unit configured to transmit an inquiry to a second communication device corresponding to a communication device adjacent to the first communication device using a plurality of channels about whether a reply to the searching request transmitted by the searching request unit has been received from the third communication device.

4. A communication device constituting an ad hoc network communicable using a plurality of channels, the communication device comprising:
a searching request unit configured to transmit a searching request addressed to a communication device being a searching destination using a plurality of channels without waiting for a reply to the searching request;
an inquiry unit configured to transmit an inquiry to an adjacent communication device using a plurality of channels about whether a reply to the searching request transmitted by the searching request unit has been received from the searching destination;
a reply unit configured to, upon receiving the searching request transmitted from another communication device and when the received searching request is addressed to an own communication device, transmit a reply to the received searching request in a manner including an instruction that the reply is held in a communication device adjacent to a searching source;
a relay unit configured to, upon receiving the searching request transmitted from another communication device and when the received searching request is not addressed to the own communication device, relay the received searching request; and
a holding unit configured to, upon receiving the reply to the searching request relayed by the relay unit from the searching destination and when the own communication device is a communication device adjacent to the searching source, hold the received reply.

5. A non-transitory computer-readable recording medium storing therein a communication device searching program that causes a first communication device constituting an ad hoc network communicable using a plurality of channels to execute a process comprising:
transmitting a searching request addressed to a third communication device corresponding to a searching destination using a plurality of channels without waiting for a reply to the searching request; and
transmitting an inquiry to a second communication device corresponding to a communication device adjacent to the first communication device using a plurality of channels about whether a reply to the searching request transmitted at the transmitting the searching request has been received from the third communication device.

6. An ad hoc network system that searches for a communication device constituting an ad hoc network communicable using a plurality of channels, the ad hoc network system comprising:
a first communication device corresponding to a searching source that searches for a communication device;
a second communication device corresponding to a communication device adjacent to the first communication device; and
a third communication device corresponding to a searching destination, wherein
the first communication device includes:
a searching request unit configured to transmit a searching request addressed to the third communication device using a plurality of channels without waiting for a reply to the searching request, and
an inquiry unit configured to transmit an inquiry to the second communication device using a plurality of channels about whether a reply to the searching request transmitted by the searching request unit has been received from the third communication device;
the third communication device includes:
a reply unit configured to, upon receiving the searching request transmitted by the searching request unit and when the received searching request is addressed to an own communication device, transmit a reply to the received searching request in a manner including an instruction that the reply is held in the second communication device; and
the second communication device includes:
a relay unit configured to, upon receiving the searching request transmitted by the searching request unit and when the received searching request is not addressed to the own communication device, relay the received searching request, and
a holding unit configured to, upon receiving the reply to the searching request relayed by the relay unit from the third communication device, hold the received reply.
